(19) United States
(12) Patent Application Publication
(10) Pub. No.: US 2006/0237939 A1
(43) Pub. Date: Oct. 26, 2006

(54) Integrated suspension assembly

(76) Inventor: William J. Hicks, Muskegon, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/404,709

(22) Filed: Apr. 14, 2006

Related U.S. Application Data
(60) Provisional application No. 60/671,799, filed on Apr. 15, 2005.

(51) Int. Cl. B60G 9/00; B60G 11/27

(52) U.S. Cl. 280/124.116; 280/124.157; 280/124.128

(57) ABSTRACT

A vehicle suspension system including a pair of trailing arms. Each of the trailing arms has a body portion with a pivot at a forward portion thereof for pivotably mounting the trailing arms to a vehicle frame. Each trailing arm further includes a rear portion integrally formed with the body portion. Each rear portion has an integral, inwardly extending axle-attachment portion, and an integral, outwardly-extending spindle portion. The vehicle suspension system further includes an elongated center axle member having opposite ends rigidly connected to the axle-attachment portions of the trailing arms and interconnecting the trailing arms.

### CROSS-REFERENCE TO RELATED APPLICATION

This application claims the benefit of U.S. Provisional Application No. 60/671,799, filed Apr. 15, 2005, the entire contents of which are incorporated by reference.

### BACKGROUND OF THE INVENTION

1. Technical Field

This invention relates to vehicle suspension systems for mounting ground-engaging wheels to a vehicle frame, and, more particularly, to a vehicle suspension having an integrated construction.

2. Description of Related Art

U.S. Pat. No. 3,547,215 to Bird (issued Dec. 15, 1970), discloses a trailing arm suspension wherein a square axle is welded to a bracket which is, in turn, secured to the trailing arm of the vehicle suspension structure. The weld securing the axle to the bracket is usually made at the mid-point of the side of the axle where vertical bending moment stresses are neutral. However, these areas are areas of high torsional loading which results from brake torque, vehicle roll and diagonal axle (wheel) walk. The welding at the mid-point of the axle may introduce a point of weakness where cracks can initiate. Furthermore, the large number of parts and associated welds associated with such a construction may cause difficulty during fabrication, thereby leading to increased cost for the assembly.

U.S. Pat. No. 4,693,486 to Pierce et al. (issued Sep. 15, 1987), discloses a trailing arm suspension in which an axle is secured to a trailing arm by a wrapper plate partially surrounding the axle. A bolt comprises the wrapper plate about the axle so that the wrapper plate supports and strengthens the axle, and a circular plug weld is positioned on the axle in a circular opening in the wrapper plate to attach the wrapper plate to the axle.

U.S. Pat. No. 5,116,075 to Pierce (issued May 26, 1992), discloses a trailing arm suspension wherein a wrapper plate is mounted to an axle through mechanical compression and without welding to the axle. Adapter plates mounted to the ends of the plate apply a compressive force to the corners of a square axle when the wrapper plate is compressed against the axle by a bolt.

Various other trailing arm suspension arrangements have been utilized. Known trailing arm suspension assemblies may include various individual components, brackets and the like that are welded together to form the final assembly. The relatively large number of parts and associated welds or other fastening arrangements may complicate the fabrication process, adding to the complexity and cost for the suspension assembly.

### SUMMARY OF THE INVENTION

One aspect of the present invention is a vehicle suspension system including a pair of trailing arms. Each of the trailing arms has a body portion with a pivot at a forward portion for pivotably mounting the trailing arms to a vehicle frame. Each trailing arm further includes a rear portion integrally formed with the body portion. Each rear portion has an integral, inwardly extending axle-attachment portion, and an integral, outwardly-extending spindle portion. The vehicle suspension system further includes an elongated center axle member having opposite ends rigidly connected to the axle-attachment portions of the trailing arms to interconnect the trailing arms.

Another aspect of the present invention is a method of fabricating an integrated axle and suspension system. The method includes casting first and second trailing arms. Each of the trailing arms has a body portion with a pivot at a forward portion thereof for pivotably mounting the trailing arms to a vehicle frame. Each trailing arm further includes a rear portion integrally formed with the body portion. Each rear portion has an inwardly-extending axle-attachment portion, and an integrally cast outwardly-extending spindle portion. The method includes providing a center axle member having opposite ends. The opposite ends of the center axle member are welded to the axle-attachment portions of the trailing arms.

Yet another aspect of the present invention is a trailing arm for a vehicle suspension system. The trailing arm includes an elongated body portion having a forward end with an opening therethrough forming a pivot, and a rear portion integrally formed with the body portion and including an integral inwardly-extending axle attachment portion, the rear portion also includes an integral outwardly-extending spindle portion.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of an integrated suspension system according to one aspect of the present invention;

FIG. 2 is a perspective view of the integrated suspension system of FIG. 1;

FIG. 3 is a partially fragmentary elevational view of the integrated suspension system of FIG. 1 attached to a vehicle frame;

FIG. 4 is a fragmentary view of a portion of the integrated suspension system of FIG. 1;

FIG. 5 is a cross-sectional view taken along the line V-V; FIG. 4;

FIG. 5A is a cross-sectional view of an alternate embodiment of the arrangement of FIG. 5;

FIG. 6 is a perspective view of an integrated trailing arm according to the present invention; and

FIG. 7 is a perspective view of the trailing arm of FIG. 6.

### DETAILED DESCRIPTION OF PREFERRED EMBODIMENT

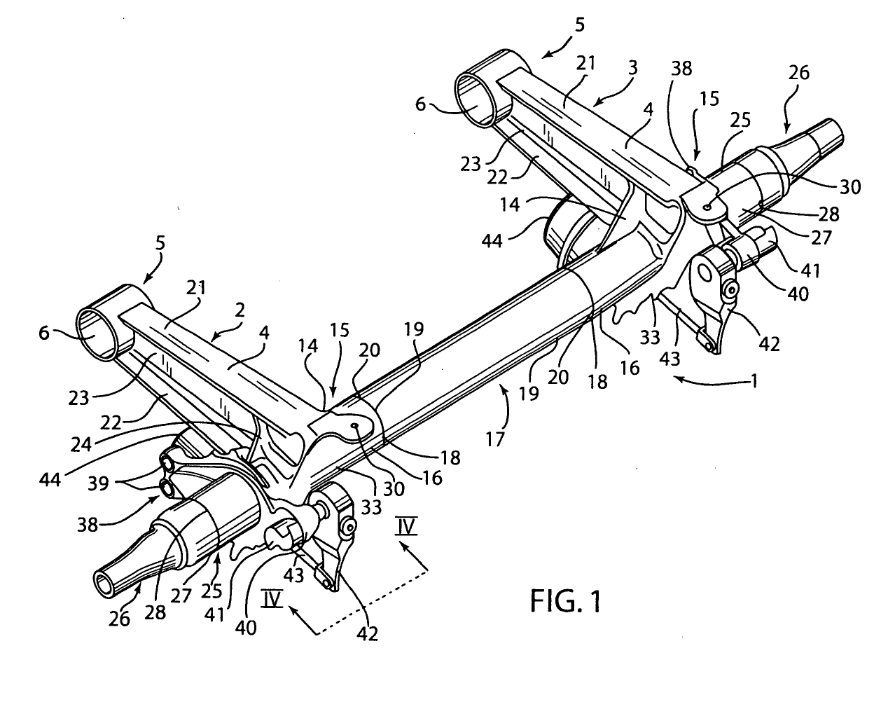

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

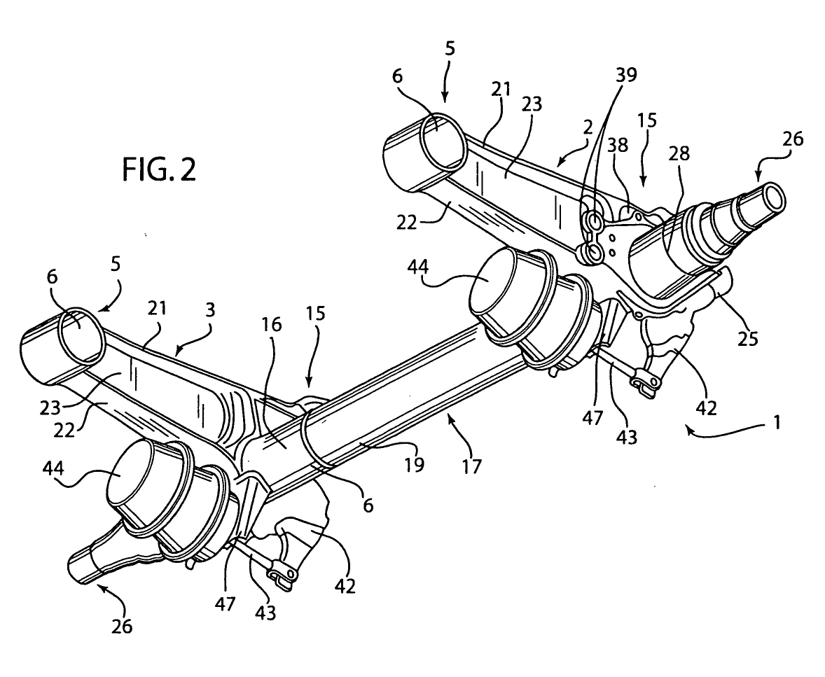

With reference to FIGS. 1 and 2, an integrated suspension assembly 1 according to the present invention includes a first trailing arm member 2 and a second trailing arm member 3.

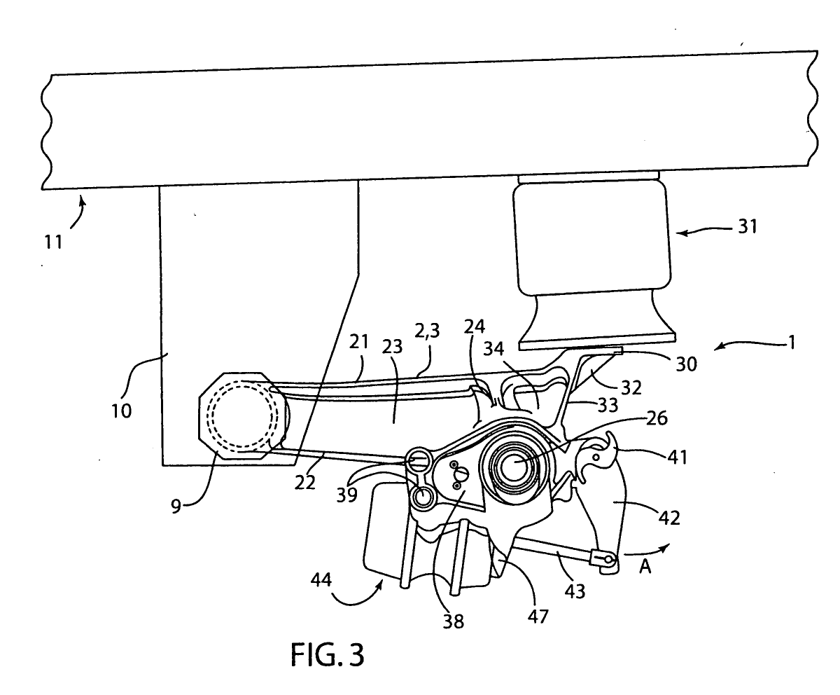

As discussed in more detail below, the first and second trailing arms 2 and 3 are cast from steel, and include a variety of integral attachment features for connecting other components of the suspension system 1. The trailing arm members 2 and 3 are mirror images of each other, such that it will be understood that each trailing arm includes substantially the same features, except for the orientation of the features. The trailing arm members 2 and 3 each include a body portion 4 having an I-shaped cross section. Forward end 5 of the trailing arms 2, 3 include an opening 6 therethrough forming a pivot for the trailing arms 2, 3. With further reference to FIG. 3, when suspension system 1 is installed to a vehicle frame 11, openings 6 receive fasteners 9 that pivotably mount the trailing arms 2, 3 to hanger brackets 10. The hanger brackets 10 are secured to a vehicle frame 11.

The rear portion 15 of the trailing arm members 2 and 3 each include an inwardly-extending portion 16 that is securely connected to an intermediate axle member 17. As described in more detail below, the ends 18 of inwardly-extending portions 16 are welded to the outer ends 19 of intermediate axle member 17 via a weld 20. The inwardly-extending portions 16 are integrally formed with the rear portion 15 of trailing arm members 2 and 3 during the casting process. The rear portion 15 of trailing arms 2 and 3 each include an integral gusset 14 that strengthens the inwardly-extending portion 16. The body portion 4 of the trailing arms 2 and 3 each include a horizontal upper web 21, a horizontal lower web 22, and a vertical web 23 that form an I-shaped cross section. The gusset 14 preferably extends from the upper web 21 and the vertical web 23 to the tubular extension 16.

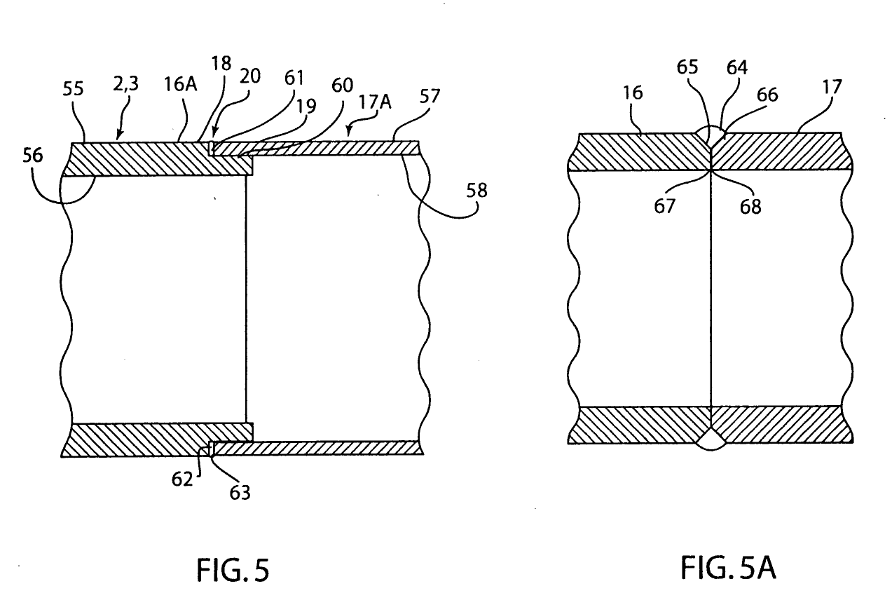

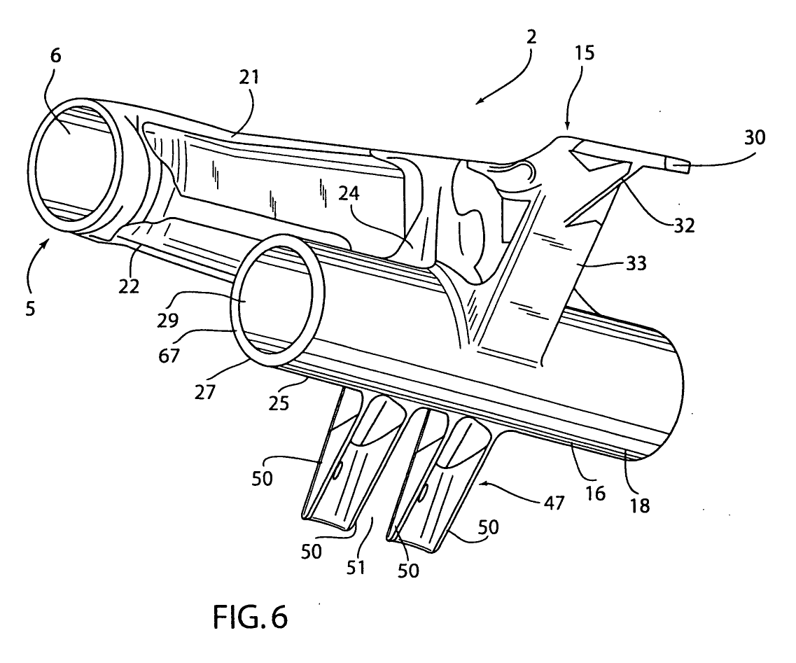

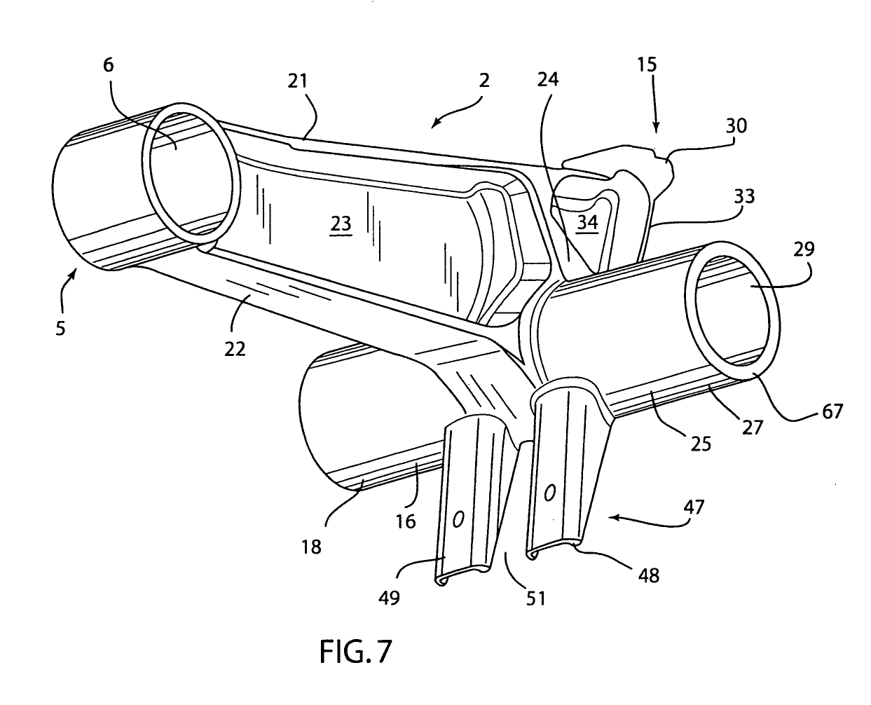

A second gusset 24 (FIG. 1) extends outwardly from the upper web 21 and vertical center web 23. The second gusset 24 reinforces outwardly extending portions 25 of trailing arms 2 and 3 (see also FIGS. 6 and 7). A circular bore 29 extends through the outwardly extending portion 25, rear portion 15, and the inwardly extending portion 16, such that the portions 25 and 16 have a substantially tubular construction. Spindle members 26 are welded to outer ends 27 of outwardly extending portions 25 along a welded joint 28. Welded joint 28 may be substantially the same as the welded joints described in more detail below in connection with FIGS. 5A and 5. Alternately, the spindles may be formed integrally with the trailing arm members 2 and 3 during the casting process, and machined to provide the proper configuration for mounting conventional bearings (not shown).

The axle members 2, 3 each include an integrally formed pad 30 utilized to mount bellows/air springs 31 (FIG. 3). The bellows/air springs 31 transmit loads from the suspension to the vehicle frame 11. A gusset 32 extends downwardly from the pad 30 to a web 33 that is integrally formed with a rear portion 34 of vertical web 23.

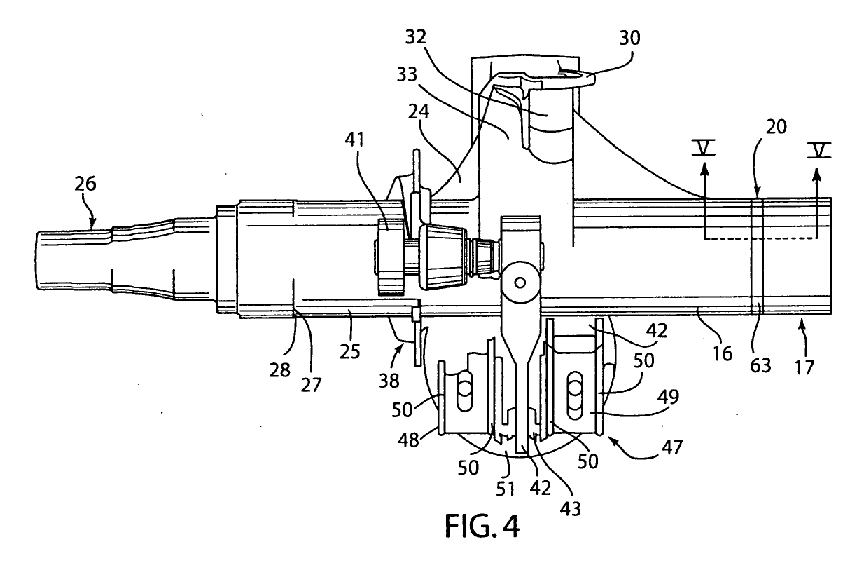

Brackets 38 include a pair of openings 39 for mounting conventional brake spiders (not shown). The brackets 38 include a rearwardly extending portion 40. S-cams 41 are rotatably mounted to the rearwardly extending portions 40. The rearwardly extending portions 40 are integrally formed with the trailing arm members 2 and 3 during the casting process and also provide a pivotable mount for slack adjusters 42. Brackets 38 may be welded to outwardly extending portions 25 of trailing arm members 2 and 3. Alternately, rearwardly extending portions and be separately fabricated, and then welded. Alternately, brackets 38 may be integrally cast with the trailing arm members 2 and 3. Push rods 43 interconnect slack adjusters 42 and brake chambers 44. During operation, actuation of the brake chambers 44 causes the push rods 43 to shift rearwardly in the direction of the arrow “A” (FIG. 3), thereby causing slack adjusters 42 and S-cams 41 to rotate. Rotation of S-cams 41 actuates the brakes (not shown) of the vehicle in a known manner. The brake chambers 44 are mounted to downwardly extending brackets 47. The brackets 47 are integrally formed with the trailing arm members 2 and 3. As illustrated in FIG. 4, bracket portions 47 comprise first and second extensions 47 and 48, each including reinforcing gussets 50. Gaps 51 are formed between the downwardly extending portions 48 and 49 to provide clearance for lower push rods 43, which extend through the gaps 51.

With further reference to FIG. 5, a welded joint 20 including weld material 63 may be utilized to securely interconnect the trailing arm members 2 and 3 to the opposite ends 19 of intermediate axle member 17A. In a preferred embodiment, the inwardly extending portions 16A have a tubular construction, with a cylindrical outer surface 55 and a cylindrical inner surface 56. Similarly, intermediate axle member 17A may also have a tubular construction with a cylindrical outer surface 57 and cylindrical inner surface 58. Alternately, the cross sections of the extensions 16A and intermediate axle member 17A may be I-shaped, square, or other suitable configuration depending upon the requirements for a particular application. The cross-sectional shapes of the inwardly extending portion 16A and the intermediate axle member 17A may be optimized utilizing known stress analysis programs such as Finite Element Analysis (“FEA”). In the illustrated example, the inwardly extending portion 16A has an annular surface 60 forming a shoulder 61 that abuts an end surface 62 of intermediate axle member 17A. The dimensions of surfaces 58 and 60 may be selected to provide a press-fit. The welded joint 28 connecting the spindle 26 to the outwardly extending portion 25 may also include a press-fit arrangement as illustrated in FIG. 5, or may include a weld joint as illustrated in FIG. 5, or other suitable weld joint. Because the ends 18 of inwardly extending portions 16A are spaced well away from the body portions 4 of the trailing arm members 2 and 3, the welded joint 20 can be readily accessed. The access permits welders and the like to be utilized to weld around the entire joint 20.

With further reference to FIG. 5A, in an alternate embodiment, an inwardly extending portion 16 may be welded to an intermediate member 17 utilizing weld material 64. In the embodiment illustrated in FIG. 5A, chamfers 65 and 66 are formed at the ends 67 and 68 of extension 16 and member 17 to permit penetration of the weld material 64.

The integrated, one piece cast trailing arm members of the present invention provide numerous attachment features for the suspension bellows/air springs, brakes, and other components. The number of parts is thereby greatly reduced, and the number of welding operations required to assemble the suspension is also greatly reduced. Also, because the weld joint that interconnects the trailing arm members to the central axle member is located away from the trailing arms, the welding operation for this joint can be performed by robotic welders or the like. The suspension of the present application provides a cost effective integrated system that alleviates numerous drawbacks associated with other welded assemblies.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. An integrated vehicle suspension system, comprising:
a pair of trailing arms, each having a body portion with a pivot at a forward portion thereof for pivotably mounting the trailing arms to a vehicle frame, each trailing arm further including a rear portion integrally formed with the body portion, each rear portion having an integral inwardly-extending axle attachment portion, and an integral outwardly-extending spindle portions;
an elongated center axle member having opposite ends rigidly connected to the axle-attachment portions of the trailing arms and interconnecting the trailing arms.

2. The vehicle suspension system of claim 1, wherein:
the opposite ends of the center axle member are welded to the axle-attachment portions of the trailing arms.

3. The vehicle suspension system of claim 2, wherein:
the axle-attachment portions and the center axle member have a tubular cross-sectional configuration.

4. The vehicle suspension system of claim 3, wherein:
the axle-attachment portions and the center axle member have cylindrical outer surface portions.

5. The vehicle suspension system of claim 1, wherein:
the rear portions of each trailing arm include an integrally formed pad configured to mount an air spring.

6. The vehicle suspension system of claim 1, wherein:
the rear portions of each trailing arm include an integrally formed downwardly extending bracket configured to mount a brake chamber of a vehicle brake system.

7. The vehicle suspension system of claim 1, wherein:
the rear portions of each trailing arm include an integrally formed, rearwardly extending bracket portion forming a pivot for mounting an S-cam of a vehicle braking system.

8. The vehicle suspension system of claim 1, wherein:
the body portion of each trailing arm has an I-shaped cross section having upper and lower horizontally extending web portions, and a vertical web extending between the upper and lower web portions.

9. The vehicle suspension system of claim 8, wherein:
the rear portions of each trailing arm include an integrally formed gusset extending between the body portion and the axle attachment portion.

10. The vehicle suspension system of claim 1, wherein:
the opposite ends of the center axle member have a tubular cross-sectional shape;
the axle attachment portions include a cylindrical end portion received within the opposite ends of the center axle member, and an annular shoulder that extends radially outwardly from the cylindrical end portion and abuts opposite end surfaces of the center axle member.

11. The vehicle suspension system of claim 1, wherein:
the rear portions of the trailing arms each include an integral forwardly-extending portion having a pair of vertically juxtaposed openings therethrough to form a brake spider.

12. A method of fabricating an integrated axle and suspension system, the method comprising:
casting first and second trailing arms, each having a body portion with a pivot at a forward portion thereof for pivotably mounting the trailing arms to a vehicle frame, each trailing arm further including a rear portion integrally cast with the body portion, each rear portion having an integrally cast inwardly-extending axle attachment portion, and an integrally cast outwardly-extending spindle portion;
providing a center axle member having opposite ends; and
welding the opposite ends of the center axle member to the axle attachment portions of the trailing arms.

13. The method of claim 12, including:
forming integral, outwardly extending spindle attachment portions on each trailing arm; and
welding spindles to each spindle attachment portion.

14. The method of claim 12, including:
forming an integral pad on the rear portion of each trailing arm; and
mounting an air spring to the pad.

15. The method of claim 14, including:
forming an integral, downwardly extending bracket on each trailing arm; and
mounting a pneumatic brake chamber to each bracket.

16. The method of claim 12, wherein:
each trailing arm is made of steel.

17. The method of claim 12, wherein:
the body portion of each trailing arm has an I-shaped cross section.

18. The method of claim 12, including:
integrally forming a gusset that extends upwardly from the axle attachment portion.

19. A trailing arm for a vehicle suspension system, comprising:
an elongated body portion having a, forward end with an opening therethrough forming a pivot, and a rear portion integrally formed with the body portion and including an integral inwardly-extending axle attachment portion, and an integral outwardly-extending spindle portion.

20. The trailing arm of claim 19, including:
an integrally formed pad adapted to mount a pneumatic spring.

21. The trailing arm of claim 20, including:
an integrally formed bracket configured to mount a brake chamber of a brake system.

22. The trailing arm of claim 21, wherein:
the body portion has an I-shaped cross section;
the inwardly extending axle attachment portion has a tubular cross section with a cylindrical outer surface.
